(19) United States
(12) Patent Application Publication
(10) Pub. No.: US 2007/0277013 A1
(43) Pub. Date: Nov. 29, 2007

(54) Method for transmitting protected information to a plurality of recipients

(75) Inventors: Blerim Rexha, Wien (AT); Albert Treytl, Wien (AT)

Correspondence Address: BELL, BOYD & LLOYD, LLP, P.O. BOX 1135, CHICAGO, IL, 60690, US

(73) Assignee: Siemens Aktiengesellschaft, Munchen (DE)

(21) Appl. No.: 10/567,972

(22) PCT Filed: Aug. 9, 2004
(86) PCT No.: PCT/EP04/51749

§ 371 Date: Aug. 22, 2006

(30) Foreign Application Priority Data
Aug. 11, 2003 (DE) 10336805.1

(51) Int. Cl. G07F 19/00

(52) U.S. Cl. 711/164

(57) ABSTRACT

The invention relates to first information which is determined for a first receiver. Said first information is transmitted together with secondary information, which is determined for a second receiver in a common information unit to the first receiver. The first information can be encrypted according to specifications of the first receiver. The secondary information, which can be made of several components, is encrypted according to the specifications of the second receiver, for example, with an open key, a so-called public key. Said public key encryption methods have various embodiments and security steps. Said methods ensure that the first receiver, upon receipt of the complete information, can not encrypt pieces of information therefor not intended therefor.

### CLAIM FOR PRIORITY

This application is a national stage of PCT/EP2004/051749 which was published on Aug. 9, 2004 and which claims the benefit of priority to German Application No. 10336805.1 filed Aug. 11, 2003.

### TECHNICAL FIELD OF THE INVENTION

The invention relates to a method for transmitting protected information to a plurality of recipients.

### BACKGROUND OF THE INVENTION

Over the last several years it has become more and more popular to make use of services or to purchase goods by way of the different communication networks. One obstacle for the user in the past has always been that sensitive data, such as account information, must also be transmitted over the network.

FIG. 1a presents a purchasing transaction such as is currently performed for example via the internet. On the one side is the customer (Consumer) who purchases merchandise from a seller (Merchant). The payment for this merchandise is to be made via his bank account. The customer now transmits his request for the merchandise to the seller. A variety of information is conceivable here, such as additional information about the customer (User Info), details of the desired merchandise (Goods), as well as information about the desired method of payment, for example a credit card number.

This information is transmitted to the seller, for instance over a secure line (SSL, Secure Socket Layer, and TLS, Transport Layer Security, a secure connection). Although the connection cannot be monitored by third parties, with this arrangement the seller too receives information which is not necessarily intended for him or required for concluding the purchasing contract, such as, indeed, the credit card number. The seller forwards said information in its entirety to the bank, in particular also the information about the purchased goods, which is not intended for the bank.

What would be desirable, however, is a procedure as illustrated in FIG. 1b, so that the seller only receives the information relevant to him concerning the ordered goods and the bank only receives the information relevant to it concerning the customer's account.

Different solutions are already known. A well-known product in the field of electronic payment methods is offered by the company SET Secure Electronic Transactions Llc. A description of said known method can be found in the specification of the software that is posted on the company's website Here, one can find a data structure which can be expanded in a user-specific manner by means of additional supplements, called “extensions”.

Even in this solution from SET, however, there is no indication of any means of storing different information that is related by content, for example credit card numbers of a plurality of providers or account details of different banks, together in a single data structure.

### SUMMARY OF THE INVENTION

The invention discloses a method for transmitting information which allows the recipients to read those parts of the information that are intended for them. Another embodiment enables the protected transmission, in a single data structure, of a plurality of data items that are related by content.

According to one embodiment of the invention, first information that is intended for a first recipient, hereinafter also called the provider, is sent in a common information unit together with second information that is intended for a second provider. In this case the first information may be encrypted in accordance with the specifications of the first provider. The second information, which may include a plurality of constituent parts, is encrypted in accordance with the specifications of the second provider, for example by means of what is referred to as a “public key”. Such “public key” encryption methods are already known in different embodiments and affording different levels of security. By means of this procedure it is ensured that the first provider, upon receiving the complete information, cannot decrypt those parts of the information that are not intended for him.

The recipient of the message will also be referred to hereinafter as the provider, since the examples described essentially deal with a purchasing transaction in the network. In this case the first recipient of the message is typically a seller, that is to say a provider of goods and services, while the second recipient of the message is a bank or financial institution, which is to say a provider of financial services. These descriptions are not meant to be restrictive, however. Other permutations are conceivable, for example an information provider that accesses further databases, a first network operator that accesses a network in a foreign country, an automobile manufacturer or police force accessing the database of the vehicle registration agency.

In another embodiment, there is an alternative solution option in which the information intended for the second provider is not sent into the network together with the first information, but can be retrieved when necessary by the information recipient from a central storage area in the network.

An implementation of the solution according to the invention that conforms to the already known X.509 standard (Series X: Data Networks and Open Systems Communication—Directory: Public Key and Attribute Certificate Frameworks, ITU-T Recommendation X.509) has proved to be particularly advantageous. An implementation based on the X.509 standard comprises a number of advantages, for this procedure is already standardized and can be used independently of already existing implementations. The data structures are defined in ASN.1 notation, which has likewise been standardized for a long time and is applied in an implementation-independent manner.

Another embodiment according to the invention is particularly advantageous for the payment transactions already referred to, which become necessary when data, information and goods are ordered or purchased over the internet or some other communication network and when the purchaser would also like to handle the payment via the network.

An approach which has proved its usefulness in the context of the already known transactions over networks has been to assign a transaction what is known as a transaction number (TAN) by means of which a purchasing transaction in the network can be provided with a unique number and also traced back subsequently.

The implementation of the information by storage in an extension of a certificate conforming to the X.509 standard can be effected in two different variations.

The certificate can be implemented as what is known as an identity certificate, which is described in ITU standard X.509, Section 2. What is advantageous with this embodiment is that the certificate becomes very compact, providing an “all in one” solution.

However, a certificate in this form can no longer be changed subsequently. For this reason there is the alternative of implementation in what is known as an “attribute certificate”. The description relating hereto can be found in Section 3 of the already cited standard. This has the advantage that the individual extensions of said certificate are independent of one another and for this reason they can be changed at any time. A certificate also does not have to be revoked: it is simply necessary to wait until its life has elapsed. In this case the system becomes more complex, however. The user has to handle different certificates and the issuer of the certificates is required to administer more Certificate Revocation Lists (CRL).

If the second solution, the attribute certificate extension, is chosen for the implementation, there is still the option in this case to choose whether said certificate can be used precisely once, what is referred as a “one time use”, or, as what is referred to as “long life use”, specifies a specific time period during which the certificate is valid.

A suitable storage medium is possible for storing the certificate and associated private key, even if the certificate is stored centrally in the network. The owner of the certificate can also store it on a smart card or smart dongle, on a storage medium that can be read contactlessly or similar. It is particularly advantageous in this case if the stored certificate is additionally protected against unauthorized access by a password, a PIN etc.

The described method can of course be used not just for the credit card number, but for all user information, such as address, blood group, insurance numbers, etc.

The information can be encrypted and signed at any time using already known methods. This ensures the information is protected against unauthorized access (i.e. its privacy).

The theft of credit card numbers, as has happened in the past for example by eavesdropping the purchasing transaction, is made even more difficult. Protection is increased further by an additional barring of access to information stored on the storage medium through the introduction of a PIN.

### BRIEF DESCRIPTION OF THE DRAWINGS

The invention is explained below with reference to exemplary embodiments in conjunction with the drawings, in which:

FIG. 1a is an overview of the connections that are currently set up during a purchasing transaction, when the purchaser effects the payment via a payment service provider in the network.

FIG. 1b shows the same transaction when the method according to the invention is applied to the payment transaction.

FIG. 2a shows the certificate extensions for a number of credit cards or similar information.

FIG. 2b shows the new private OID conforming to X.660.

FIG. 3a shows the exemplary format for a customer request in a purchasing transaction.

FIG. 3b shows the format for the response of the first provider.

FIG. 3c shows the format for the signed response of the customer.

FIG. 3d shows the format for the authentication data from the second provider, also signed.

FIG. 3e shows the format for a second customer request.

FIG. 3f shows the format for a third customer request.

FIG. 3g shows the format for a fourth customer request.

FIG. 3h shows a further exemplary format for the authorization data from the second provider, also signed.

FIG. 4 shows a purchasing transaction in four steps.

FIG. 5 shows a purchasing transaction in eight steps.

FIG. 6 shows a purchasing transaction in ten steps.

FIG. 7 shows a purchasing transaction with errors occurring.

FIG. 8 shows the structure of the SICRYPT secure token.

FIG. 9 shows the X.509 certificate extension structure.

### DETAILED DESCRIPTION OF THE INVENTION

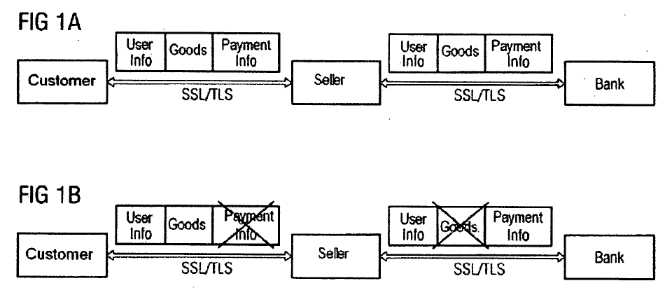

FIGS. 1a and 1b show, as already described in the introduction, the exemplary sequence of steps in a purchasing transaction. Shown in the boxes above the arrows is the respective information that flows between the individual method participants. The purchaser (Consumer) makes contact via the seller (Merchant). No direct communication takes place between the purchaser and the bank. The information flows via the seller. The result is that the seller also receives information that is irrelevant to his sales transaction. By means of the method according to the invention, as shown in FIG. 1b, although all the information is transferred to the seller, the latter cannot read said information without restriction. For example, the payment information (e.g. credit card number, Payment Info), shown crossed out in this case, is not displayed to the seller. Other information, for instance who the customer is (supplementary info, User Info) and what this customer would like to order (Goods), is freely accessible to him.

Current public key certificates attempt to map a certificate (public and private key) onto a complete user profile. However, the number of applications has expanded, so more than one application (in connection with web services, for example) is required.

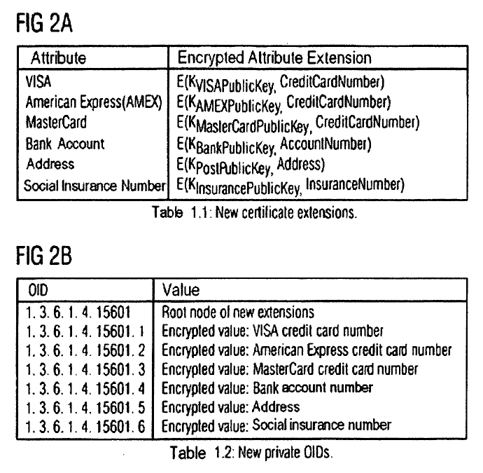

The invention uses an already known X.509 certificate for this and extends the certificate with additional information. The information is encrypted and stored in this form in the certificate. A table illustrating this is shown in FIG. 2a.

The original X.509 standard was drafted in order to develop a globally consistent name for users in a network, without a double occurrence thereof, in what is referred to as an X.500 Directory. The X.500 Directory is a database that is intended for worldwide user, such as an international telephone directory. The X.509 certificate is digitally signed and issued by a certification authority in order to confirm the identity of the owner and additional information. For the purpose of secure communication with other users, public key methods make provision for generating two keys: a private key (which remains secret) and a public key which can be passed on to anyone. The X.509 certificate combines the public key and the name of the owner of the private key.

The advantage of the X.509 standard is that it was developed for general use. Here, the quite general problem of authentication in distributed systems is solved and its solution concept is implementation-independent.

In version 3 of the X.509 standard, which was published in 1996, so-called “extensions” were introduced with which anyone can implement additional data fields and introduce these into their data structure. The extensions are also referred to as private, proprietary, or custom extensions. They carry unique information that is of importance to the certificate owner or certificate issuer. Extensions known to date are currently what are known as “key usage limits”, which restrict the use of a key to a specific purpose, or “alternative names”, which enable the public key to be linked with other names such as: domain names, e-mail addresses, etc. The certificate extensions can also be marked as critical in order to indicate that the extension requires checking.

In the exemplary case of a payment transaction the user shares various “secrets”, that is to say data which is only to be made known to the direct communication partner, with different participants, for example a credit card number in the case of a credit card issuer such as American Express, Visa, Master Card, etc., or the account number with a bank, or the insurance number with an insurance institution. Other personal information, such as, for example, the address, is conceivable.

The owner of the certificate knows these extensions. Each individual extension is then encrypted in such a way that the relevant partner with the right identity can decrypt the corresponding data again.

The known public key cryptography method, for example, can be used for this purpose. The respective public key of the insurance institution, bank or credit card issuer is then used for the encryption. Said key is used when the certificate is issued. The certificate is then stored in a public directory, because the respective issuer of the information can decrypt (understand) said information using his private key.

The extensions are defined in the X.509 standard in ASN.1 notation. FIG. 2a shows an exemplary embodiment of a possible certificate extension issued for a user. The user possesses three different credit cards (Visa, AmeX, MasterCard), a bank account, an address (also encoded), and a social insurance number.

The individual extensions are identified by what are referred to as “object identifiers” (OIDs). The OID is unique, which means that, for example, each field including a credit card number from a specific credit card institution (for example Visa) has the same object ID. In the example shown in FIG. 2b this OID, this so-called number, is 1.3.6.1.4.15601.1. The definition of this object identifier OID can be found in ITU-T Recommendation X.660. The OID can either be stored in a tree structure, which means that all extensions have the same parent node. This case is shown in FIG. 2b. However, it is also possible that the extensions are company-dependent. This means that the extensions are mounted at various points of the tree.

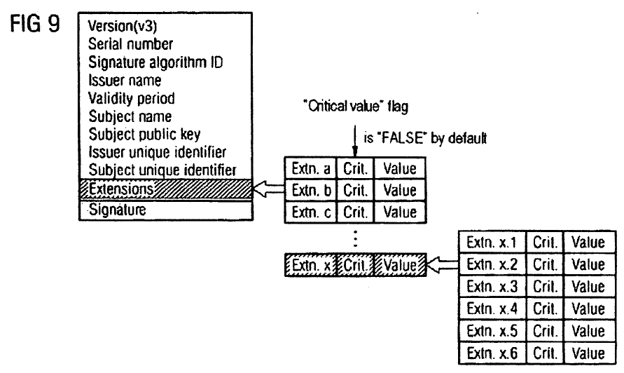

A representation of the X.509 certificate in a tree structure is also shown in FIG. 9. It can also be seen in FIG. 9 that this extension can exist not merely as a designation and a value, but can be supplemented with further information. In the described case in FIG. 9 there exists a further field (Crit.), which can symbolically assume the value “true” or “false”. If the value is set to true, this means that the extension is to be interpreted as critical. A possible reaction to this critical value may be that the application which receives the certificate and does not understand this extension has to reject the certificate as invalid. If the critical flag is set to false, the application can still use the certificate even if it does not understand the extension.

The certificates can be stored in various ways. The standard method is to store them centrally in the network in a directory.

Advantageously, however, the owner of the certificate can also carry it about with him on a suitable storage medium. A known method for storing such information is to use chipcards known as “smart cards”. The smart cards are already familiar to the person skilled in the art. An advantage with using a smart card is that access to the memory in which the certificate (actually the private key) is stored can additionally be protected by means of a PIN or corresponding password. If the PIN is entered incorrectly a number of times, access to the memory of the card is then blocked. Other storage media are possible, however.

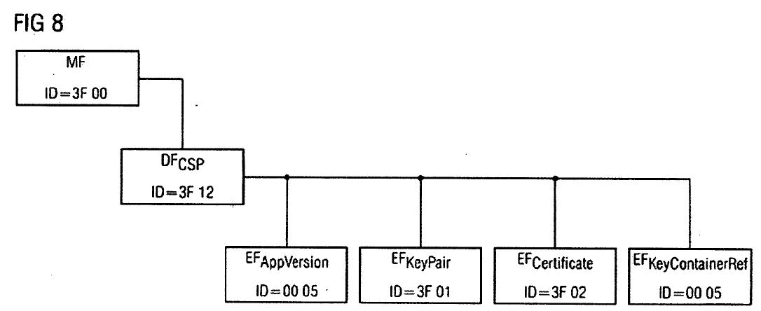

FIG. 8 contains a representation of the Infineon Sicrypt Secure Token platform. This platform offers two levels of memory access. The user level is protected by means of a “user PIN” and the second level by means of a further “administrator PIN”. The “administrator PIN” can be used to unlock the card again if the “user PIN” has been wrongly entered a number of times.

Storing the certificate on a smart card has the following advantages:
Security:
The X.509 certificate and the associated private key are stored in two different files called “elementary files” (EF); see FIG. 8. Write access to the corresponding file DF_{CSP} is protected by means of an access code. The elementary file EF_{Keypair} is protected in the same way. Any application or service requiring access to the private key must receive precisely this access code from the user. On the other hand, the storage location of the EF_{Certificate} can always be read, i.e. is not protected. In this case propagating the certificate into the system therefore simply means copying the certificate to the system.
Mobility:
Smart cards are portable storage media and because of their small size the user can carry them around with him for example in his briefcase. He can also use them on his PC with a corresponding reader device, as well as on public terminals (in an internet café, for example). At the same time the user need have no fear that the private key will be copied or remain in the system. Even if the user loses his smart card, the latter cannot be accessed without the access code (PIN).
Compactness:
As a result of the inventive storing of the different payment options (all credit card numbers and all account numbers, for example) on a card, the latter is particularly compact. Storing information in this way in a data structure is so far not known to the person skilled in the art. Moreover, further information (for example the address, etc.) can be integrated, thereby making the user profile even more compact.

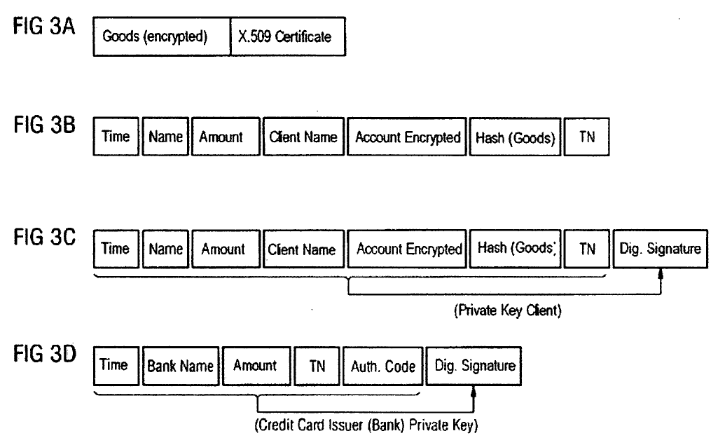

The execution of a payment transaction using the X.509 certificate will now be described below. FIGS. 3a to 3h illustrate different formatting options for the individual messages which can be used by the user, the seller or the bank in the course of the payment transaction. Said messages are transmitted for example over the internet; other mobile radio or fixed networks are conceivable.

A precondition of the method is that the product has already been selected by the user, and also that the price of the product has been negotiated. The message units are described at Application Level, which means that no byte structures are specified. Furthermore, the participants in the method are “online”, in other words permanently connected to the network.

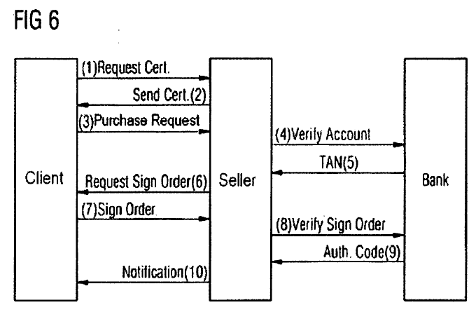

In an exemplary first sequence the customer (Consumer), the seller (Merchant) and the bank are connected via a network, the internet for example. This is not intended to represent any restriction on the method, however, and other connection means are possible. Steps 1 to 10 in FIG. 6 are executed in sequential order. It is assumed here that the exchange of the X.509 certificate between the seller (merchant) and the bank has already taken place.
1. The customer requests the public key from the merchant (seller), assuming he does not yet have it (Request Cert.).
2. The seller sends his certificate (Send. Cert.) to the customer.
3. The customer validates the certificate. In the process he checks, for example, whether or not the time validity has expired yet and whether the certificate has been issued by a trusted authority. The customer then sends his purchase request to the seller (Purchase Order). The purchase request can have the format as shown in FIG. 3a. In this case the details of the goods to be purchased are encrypted by means of the seller's public key (E(Merchant_{pulickey}, goods), while on the other hand the X.509 certificate is not encrypted. Sending the X.509 certificate in this message is optional. Otherwise the seller retrieves said certificate from a public directory. Only that part of the certificate is encrypted which includes the credit card information, as described previously.

4. The seller decrypts said message using his private key. Here, too, he checks the validity of the certificate against the following conditions:
Was the certificate issued by a trusted authority?
Has the life of the certificate been exceeded? and
Is the certificate not in the CRL (Certificate Revocation List)?

If the certificate fails to meet one of the above-mentioned criteria, the seller marks it as invalid and terminates the session with the customer.

Otherwise, in other words if the certificate is valid, the seller sends the customer's certificate to the bank or to the credit card issuer (Verify Account) in order to verify the credit card number specified in the certificate. Said credit card number is stored, as already described, in the private extension of the X.509 certificate and is to be taken therefrom only in encrypted form.
5. The bank checks the X.509 certificate received from the customer. The check includes the following:
   Does the certificate come from a trusted certificate authority?
   Has the certificate expired?
   Is the certificate contained in the CRL (Certificate Revocation List), and
   Does the certificate have the extensions that contain the information about credit card numbers or account numbers?

If the certificate is recognized as valid, the bank now checks the account specified in the extension. If the account is frozen or overdrawn, the bank sends a negative response to the seller. It is possible that a predefined set of response codes is programmed for every possible status of the customer account in order to propagate this customer status.

However, if the X.509 certificate has also been checked positively in this second check, that is to say the account exists and can be debited, then the bank returns a special code, also known as a transaction number (TAN), to the seller. The TAN is usually a random number that is intended to uniquely identify this transaction.

This transaction number can also be proven with two flags, a “requested” and a “used” flag. When the transaction number is sent to the seller, the status is set to “requested”. In this way the bank can prevent attempted forgery by copying this transaction number. The bank encrypts the transaction number using the seller's public key and sends it back to the seller.
6. The seller evaluates the bank's response and decrypts it using his private key.
   If the response is negative, the seller terminates the session with the customer.
   In the opposite case, i.e. if the response is positive, a transaction number of the bank must be included. The seller formats the response to the customer's purchase request; this response is represented by way of example in FIG. 3b. Included here is the sum involved (Amount), the name of the customer (Client Name), the encrypted account number which was taken from the X.509 certificate (Account Encrypted), then the requested merchandise (Goods) and the transaction number (TN) supplied by the bank. The time corresponds to the time on the seller's server and the name corresponds to the seller's official name, as also used in normal credit card transactions. The customer name and customer account are taken from the customer's certificate. To guarantee increased privacy, the inserted goods can also be encrypted, represented here by a hash function. The complete data record is then encrypted using the customer's public key and sent to the customer (Request Sign Order). The seller advantageously stores this request, in particular the address and the merchandise (Goods), for a subsequent send process.
7. The customer receives the message from the seller and digitally signs it (Dig. Signature). This can be seen in FIG. 3c. He uses his private key (Private Key Customer) for the signing. As an option he can check his goods with the aid of the hash function. The digital signature plays a dual role here: It ensures on the one hand that the data has not been changed during the transmission, and on the other hand that the addressed customer corresponds to the customer that sent the original request. In this way it ensures that the customer is actually the owner of the X.509 certificate. The customer now encrypts the complete message using the seller's public key and sends it back to the seller (Sign Order).
8. The seller receives the encrypted message and decrypts it using his private key. He then encrypts it using the public key of the bank or the credit card institution. In this step the seller acts only in a router function (Verify Sign Order). The format of the message corresponds to that in step 7; see FIG. 3c.
9. The bank decrypts the message received from the seller using its private key. The signature of the customer request is then verified. The transaction number, which must be present in the message, is set to “requested”, as described previously. Otherwise this is an indication that the seller has attempted to duplicate the message. After receiving the transaction number the bank sets the second flag for the transaction number in its database to “used”. The bank now generates an authorization code and formats the data as indicated in FIG. 3d. Time and bank name correspond to what was described in step 6. For the sake of security the bank can now digitally sign this message with its authorization code. The complete message is then encrypted with the aid of the seller's public key and sent to the seller (Auth. Code).
10. Provided the authorization code of the received message is positive, the seller sends his goods or provides the purchaser with the requested service. He then also collects the requested amount of money from the credit card institution or bank. The seller then informs the customer that the transaction has been successfully completed (Notification). This message is again encrypted using the customer's public key.

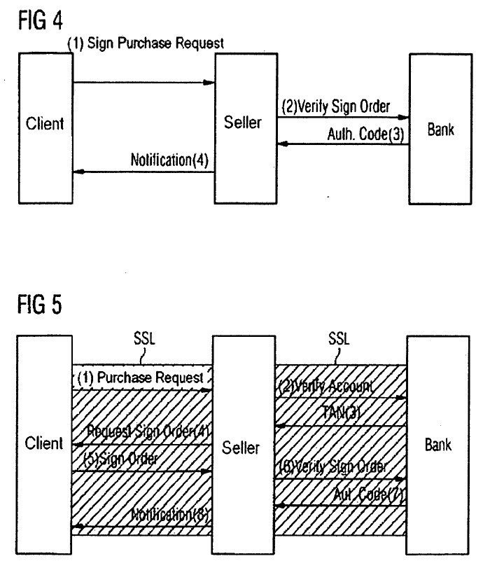

The transaction process described in the foregoing can also be reduced in terms of the number of steps, however (refer to FIG. 5). A precondition in this case is that a secure communication is established, for example via SSL, between each two participants, the customer and the seller, and the seller and the bank. It is further assumed that a mutual authentication, based on the X.509 certificate, has already taken place between the respective participants.

Steps 1 to 8 are executed sequentially. The format of the data packets is the same as described in the preceding example of FIG. 6. In this case there is no requirement for encryption since the encryption is already guaranteed by the SSL connection. For this reason two steps are saved in this process. In principle the first two steps of the process in FIG. 6 are saved, with the result that step 1 in FIG. 5 corresponds to step 3 in FIG. 6. Step 2 in FIG. 5 corresponds to step 4 in FIG. 6, and so forth.

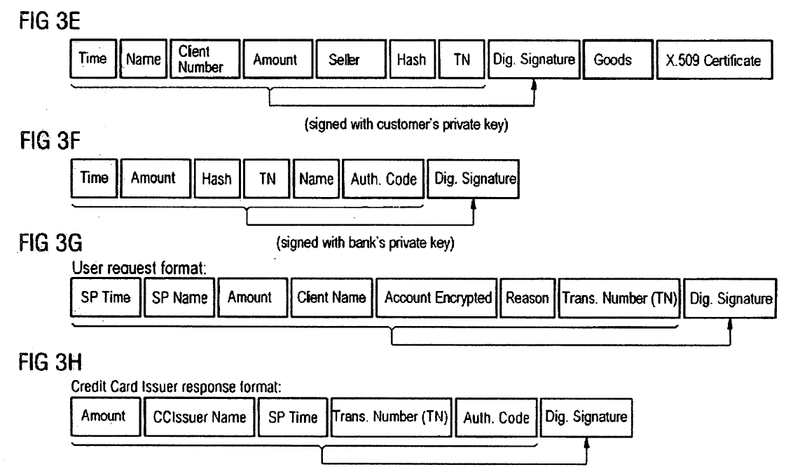

A sales transaction with a minimal exchange of messages is shown in FIG. 4. In the two preceding examples the transaction was performed in two steps, the placing of the order and, in the second step, the signing of the order. FIG. 4 now shows a transaction in which both steps are combined in a single step. Furthermore, in this procedure there is also no need for a transaction number of the bank. In this case the transaction number is generated by the customer himself.

The message flow operates as follows:
1. The user prepares a request (Sign Purchase Request), generates a transaction number (which in this case is a truly random number TN) and is used to counter copying attacks. The format of the message is illustrated in FIG. 3e. The field “Time” represents the transaction time at the customer. Name and customer number are values that were taken from the customer's X.509 certificate. The sum involved (Amount) represents the total value of this purchasing transaction.
   The seller (Merchant) is used as a name or also as an ID, as is customary in credit card transactions. A hash value enables the customer to encrypt his list of ordered goods vis-à-vis the bank, and the hash algorithm is known to the person skilled in the art.
   The message also includes a digital signature (Dig. Signature) which signs the preceding data. This signature assures the seller and the bank that the customer has initiated the transaction himself and that he is the owner of the corresponding private key and that the transaction data has not been changed during the transmission.
   The field “Goods” represents the goods that have been selected by the purchaser and are to be purchased or else the service. This field is readable for the seller so that the request can be completed in case of doubt.
   The customer appends his X.509 certificate, with the encrypted credit card numbers contained in the extensions, to the message. If this message is distributed via the internet, the customer should additionally encrypt it using the seller's public key.
2. The seller checks the customer's certificate against the following conditions:
   Was the certificate issued by a trusted authority?
   Has the life of the certificate expired? and
   Is the certificate contained in the CRL (Certificate Revocation List)?
   If the check of the certificate produces an error message, the seller marks the certificate as invalid and terminates the session with the customer. The seller also has the option of checking the digital signature, for example by checking whether the customer owns the corresponding private key. The seller removes the field “Goods” from the included message in order to ensure that this information does not reach the bank and forwards the rest of the message to the bank (Verify Sign Order).
3. The bank checks the customer's X.509 certificate on the basis of the following points:
   Was the certificate issued by a trusted authority?
   Has the certificate expired?
   Is the certificate contained in the CRL (Certificate Revocation List)? and
   Does the certificate have the private extensions including the customer's credit card number or account number?
If the certificate is proved to be valid, the bank verifies the digital signature in order to ensure that the transaction has actually been initiated by the customer. The bank then checks the customer's account or the credit card account contained in the X.509 certificate. If the account number is blocked or the account overdrawn, the bank sends a negative response to the seller. In the opposite case, i.e. if the account is available, the bank sends back a response (Auth. Code), as shown in FIG. 3f. In this case the field “Name” denotes the name of the bank or credit card institution. The bank then signs this message with its private key (signed with bank's private key).
4. In the final step, after receiving the positive authorization code, the seller makes the goods or the requested services accessible to the purchaser (Notification). The seller also collects the requested money from the credit card institution.

The protocol described in this section can also be executed for example via http (HyperText Transfer Protocol) or https (HyperText Transfer Protocol Secure). In the case of http the messages should be encrypted using the respective public key of the sender. If another secure network exists between the seller and the bank, for example a private bank network or a VPN (Virtual Private Network), the encryption can be dispensed with.

FIGS. 3g and 3h shows further message formats which can be used as alternatives to those already described from FIGS. 3a to 3f. The message shown in FIG. 3g, for example, has a different format for the message from FIG. 3c. FIG. 3h shows a message format corresponding to FIG. 3d. This is intended to make clear that the corresponding message formats are of an exemplary nature only and can of course be modified, for example with supplementary fields.

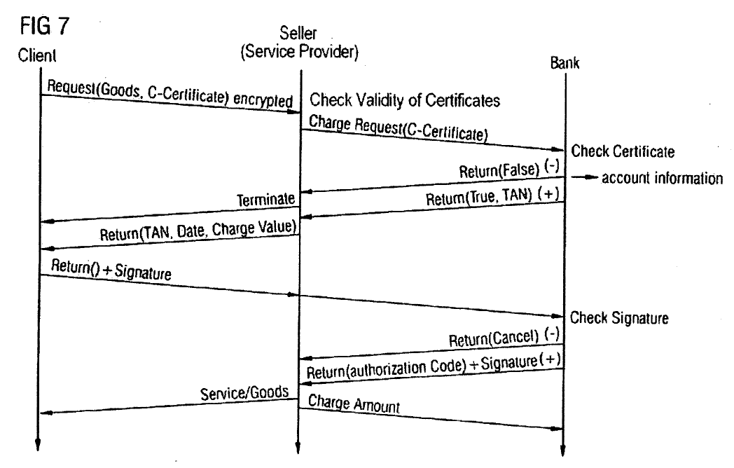

The process shown in FIG. 7 essentially corresponds to the procedure illustrated in FIG. 6, with the sole exception that the negative responses (Return(False)) from certificate checks with a negative outcome are also inserted.

An implementation of the inventive idea has already been tested. In this trial Windows XP was used as the operating system, NET Studio as the development environment, WSE (Web Service Enhancements) as an extra module for generating X.509 certificates, CAPICOM modules for manipulating the certificates, for example, signing, decrypting, encrypting, verifying, etc., Open SSL for issuing the necessary certificate extensions, the Infineon Sicrypt smart card as the smart card, and associated tools for installing the certificates.

What is claimed:

1. A method for transmitting protected information, comprising:
transmitting first information from a user of a telecommunication network to a first provider; and
transmitting second information from the user to a second provider,
wherein the first information is encrypted in accordance with specifications of the first provider,
the second information includes a single- or multi-part component which is encrypted in accordance with specifications of the second provider, and
the information is sent in a common information unit.

2. A method for transmitting protected information comprising:
transmitting first information from a user of a telecommunication network to a first provider; and
transmitting second information from the user to a second provider,
wherein the first information is encrypted in accordance with specifications of the first provider,
the second information includes a single- or multi-part component which is encrypted in accordance with specifications of the second provider and,
the second information is stored by the first or second seller in a data memory which can be accessed by the first and second seller.

3. The method as claimed in claim 1, wherein
a private extension of a certificate conforming to the X.509 standard is used for storing the second information.

4. The method as claimed in claim 1, wherein
the method is used for a payment transaction and the transmitted first and/or second information relates to the payment transaction.

5. The method as claimed in claim 4, wherein
a unique transaction number is assigned to the payment transaction by the second provider or by the user.

6. The method as claimed in claim 4, wherein
an identity certificate extension is used.

7. The method as claimed in claim 4, wherein
an attribute certificate extension is used.

8. The method as claimed in claim 7, wherein
an attribute certificate can be used precisely once.

9. The method as claimed claim 1, wherein
a suitable storage medium, smart dongle or a storage medium that can be read contactlessly, is used for storing the certificate.

10. The method as claimed in claim 1, wherein
the certificate is stored on the storage medium, protected by a password.
